(19) United States
(12) Patent Application Publication
(10) Pub. No.: US 2025/0133185 A1
(43) Pub. Date: Apr. 24, 2025

(54) INFORMATION PROCESSING DEVICE

(71) Applicant: TOYOTA JIDOSHA KABUSHIKI KAISHA, Aichi-ken (JP)

(72) Inventors: Hironori AOKAGE, Nagoya-shi (JP); Ryosuke MATSUOKA, Nishinomiya-shi (JP)

(21) Appl. No.: 18/906,173

(22) Filed: Oct. 4, 2024

(30) Foreign Application Priority Data
Oct. 23, 2023 (JP) 2023-181687

(51) Int. Cl. H04N 5/77; G06V 20/56; H04N 7/18

(52) U.S. Cl. CPC H04N 5/77; G06V 20/56; H04N 7/181

(57) ABSTRACT

The information processing device is mounted on a vehicle including a plurality of cameras. The control unit of the information processing device decides the order of priority of the plurality of recorded data recorded by the plurality of cameras in response to the occurrence of a predetermined event during parking of the vehicle. At this time, the control unit decides the order of priority of the plurality of pieces of recording data so that the recording data having the highest relevance to a predetermined event among the plurality of pieces of recording data becomes the highest. The control unit uploads a plurality of pieces of recording data to a predetermined server in an order corresponding to the decided order of priority.

### CROSS-REFERENCE TO RELATED APPLICATION

This application claims priority to Japanese Patent Application No. 2023-181687 filed on Oct. 23, 2023, incorporated herein by reference in its entirety.

### BACKGROUND

### 1. Technical Field

The present disclosure relates to an information processing device.

### 2. Description of Related Art

A system for issuing an alarm when a suspicious person is sensed in an image shot by a shooting device, and technology for changing a sensing range of a suspicious person according to a parked position of a vehicle is known (e.g., see Japanese Unexamined Patent Application Publication No. 2020-149088 (JP 2020-149088 A)).

### SUMMARY

An object of the present disclosure is to provide technology that is effective in ensuring security of a vehicle.

The present disclosure can be understood as being an information processing device installed in a vehicle that is equipped with a plurality of cameras.

The information processing device in this case includes a control unit that is configured to execute, for example,
deciding, in accordance with a predetermined event occurring while the vehicle is parked, an order of priority of a plurality of pieces of recorded data recorded by the cameras, and uploading the recorded data to an external server in an order in accordance with the order of priority that is decided.

The present disclosure can also be understood as being an information processing method in which a computer installed in a vehicle executes processing of the above information processing device. The present disclosure can also be understood as being an information processing program that causes a computer installed in a vehicle to execute the above information processing method, or as a non-transitory storage medium storing the information processing program.

According to the present disclosure, technology that is effective in ensuring security of a vehicle can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a system according to an embodiment;

FIG. 2 is a diagram illustrating an example of a software configuration of the in-vehicle device according to the embodiment;

FIG. 3 is a diagram illustrating exemplary order of priority in the embodiment; and

FIG. 4 is a flowchart illustrating a processing flow executed by the in-vehicle device according to the embodiment.

### DETAILED DESCRIPTION OF EMBODIMENTS

As a service for securing security of a parked vehicle, a service for uploading recording data of a camera to an external server when a predetermined event occurs in a parked vehicle has been studied. In such a service, the user of the vehicle can confirm the recorded data uploaded to the server by notifying the user of the occurrence of a predetermined event from the external server.

Incidentally, when the above-described service is performed, it is also assumed that the capacity of recorded data that can be uploaded from the vehicle to the server at the time of occurrence of a predetermined event per time, the communication time length that can be spent for uploading, or the like, is limited. Therefore, in a vehicle including a plurality of cameras, there is a possibility that recording data having high relevance to a predetermined event cannot be uploaded to a server. This may also make it difficult to secure the security of the vehicle.

Therefore, in the information processing device according to the present disclosure, the control unit decides the order of priority of the plurality of recording data recorded by the plurality of cameras in response to the occurrence of a predetermined event during parking of the vehicle. As an example, in a vehicle equipped with a first camera that shoots the front of the vehicle, a second camera that shoots the rear of the vehicle, a third camera that shoots the surroundings of the vehicle, and a fourth camera that shoots the interior of the vehicle, if a predetermined event is sensing of intrusion into the interior of the vehicle, the control unit may decide the order of priority of the recording data of the fourth camera to be the highest. Further, in the vehicle equipped with the first to fourth cameras, if the predetermined event is impact sensing, the control unit may decide the order of priority of the recording data of the third camera as the highest priority.

In addition to the first to fourth cameras, in a vehicle equipped with a sensor (for example, a multi-axis acceleration sensor or the like) capable of identifying a direction in which the vehicle has received an impact, the control unit may determine a direction in which the vehicle has received an impact based on a detection signal of the sensor, and decide an order of priority according to the determination result. As an example, in a case where it is determined that the vehicle has received an impact from the front, the control unit may decide the order of priority of the recording data of the first camera as the highest priority. In addition, when it is determined that the vehicle has received an impact from the rear side, the control unit may decide the order of priority of the recording data of the second camera as the highest priority. In addition, when it is determined that the vehicle is subjected to the impact from the side, the control unit may decide the order of priority of the recording data of the third camera as the highest priority.

When the order of priority of the plurality of recording data is decided by the above-described procedure, the control unit uploads the plurality of recording data to the server in accordance with the decided order of priority. That is, the control unit first uploads the recording data with the highest order of priority to the server.

According to the information processing device of the present disclosure, it is possible to preferentially upload recorded data having high relevance to a predetermined event among a plurality of recorded data recorded by a plurality of cameras to a server. As a result, even when the capacity of recorded data that can be uploaded from the vehicle to the server at the time of occurrence of a predetermined event per time or the communication time length that can be spent in uploading is limited, it is possible to more reliably upload recorded data that is highly related to a predetermined event to the server.

Note that the recording by each of the plurality of cameras may be always performed while the vehicle is parked, or may be started by triggering the occurrence of a predetermined event. In a case where the recording by each of the plurality of cameras is always performed while the vehicle is parked, only the recording data of a predetermined time length including the time when and before and after the occurrence of the predetermined event may be uploaded to the server. Alternatively, all the recording data from the recording start point to the upload start point may be uploaded to the server.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### EMBODIMENT

In the present embodiment, an example in which the information processing device according to the present disclosure is applied to a system for monitoring a parked vehicle will be described.

### Summary of System

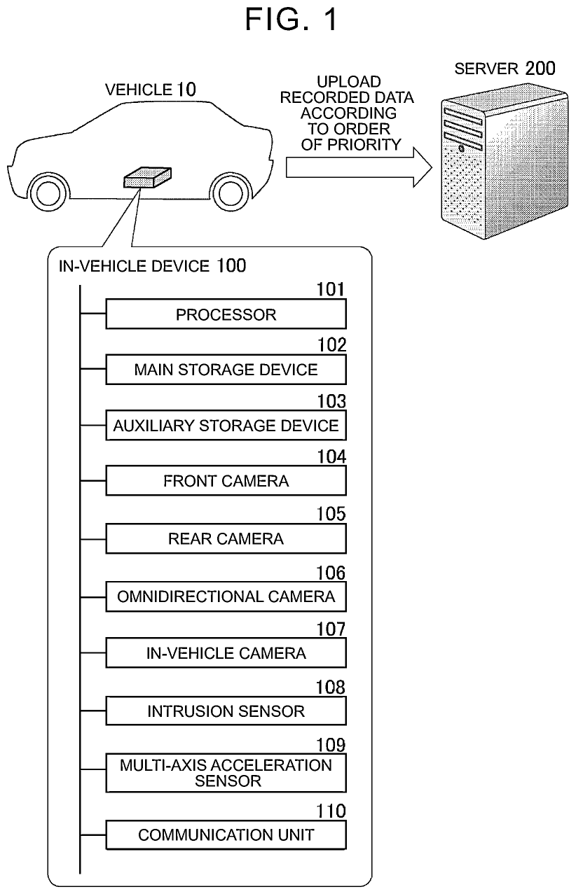

FIG. 1 is a diagram illustrating an outline of a system according to the present embodiment. The system according to the present embodiment includes an in-vehicle device 100 and a server 200. The in-vehicle device 100 and the server 200 are connected to each other through a network. The network is, for example, a WAN or another communication network that is a global public communication network such as the Internet.

The in-vehicle device 100 is a computer mounted on the vehicle 10 and corresponds to an “information processing device” according to the present disclosure. In one example, as illustrated in FIG. 1, the in-vehicle device 100 includes a processor 101, a main storage device 102, an auxiliary storage device 103, a front camera 104, a rear camera 105, an all-around camera 106, an in-vehicle camera 107, a multi-axis acceleration sensor 109, and a communication unit 110. In the example illustrated in FIG. 1, only the hardware configuration related to the parking monitoring is extracted and illustrated, but the in-vehicle device 100 may include other hardware configurations.

The processor 101 is an arithmetic processor such as a Central Processing Unit (CPU) or a Digital Signal Processor (DSP). The processor 101 loads a program stored in the auxiliary storage device 103 into the main storage device 102 and executes the program, and controls the in-vehicle device 100 through the execution of the program.

The main storage device 102 includes, for example, Random Access Memory (RAM) and Read Only Memory (ROM). The main storage device 102 provides a storage area and a work area for loading programs stored in the auxiliary storage device 103. The main storage device 102 is used as a buffer for arithmetic processing by the processor 101.

The auxiliary storage device 103 is, for example, Erasable Programmable ROM (EPROM) or Hard Disk Drive (HDD). The auxiliary storage device 103 may include a removable medium, that is, a portable recording medium. The removable medium is, for example, a disc recording medium such as Universal Serial Bus (USB) memory, Compact Disc (CD), or Digital Versatile Disc (DVD). The auxiliary storage device 103 stores various programs, data used by the processor 101 when executing the programs, and the like. The program stored in the auxiliary storage device 103 includes, in addition to Operating System (OS), a dedicated program for causing the processor 101 to execute a process related to parking monitoring. Further, the data stored in the auxiliary storage device 103 includes recording data of each of the front camera 104, the rear camera 105, the omnidirectional camera 106, and the in-vehicle camera 107.

The front camera 104 performs image-capturing of an image of the front of the vehicle 10. The rear camera 105 performs image-capturing of an image of the rear of the vehicle 10. The full-circumference camera 106 performs image-capturing of an image of the surroundings of the vehicle 10 (a range of 360° centered on the vehicle 10 in a plan view). The in-vehicle camera 107 performs image-capturing of an image of the interior of the vehicle 10. In the following description, the front camera 104, the rear camera 105, the all-surrounding camera 106, and the in-vehicle camera 107 may be collectively referred to as cameras 104 to 107.

The intrusion sensor 108 detects a moving object (for example, a person) that has entered the interior of the vehicle 10. The intrusion sensor 108 is, for example, an infrared sensor or an ultrasonic sensor. The multi-axis acceleration sensor 109 detects acceleration in a plurality of directions including the front-rear direction, the left-right direction, and the height direction of the vehicle 10. In the present embodiment, the detection signal of the multi-axis acceleration sensor 109 is used to determine the direction of the impact received by the parked vehicle 10.

The communication unit 110 is a communication interface for connecting the in-vehicle device 100 to a network. In one embodiment, the communication unit 110 includes a network interface that connects to a network using a radio communication system such as a mobile communication system (e.g., Long Term Evolution (LTE), LTE-Advanced, 5th Generation (5G), or 6th Generation (6G)) or a Wi-Fi (registered trademark). The communication unit 110 communicates with the server 200 through a network. Software configuration of the in-vehicle device

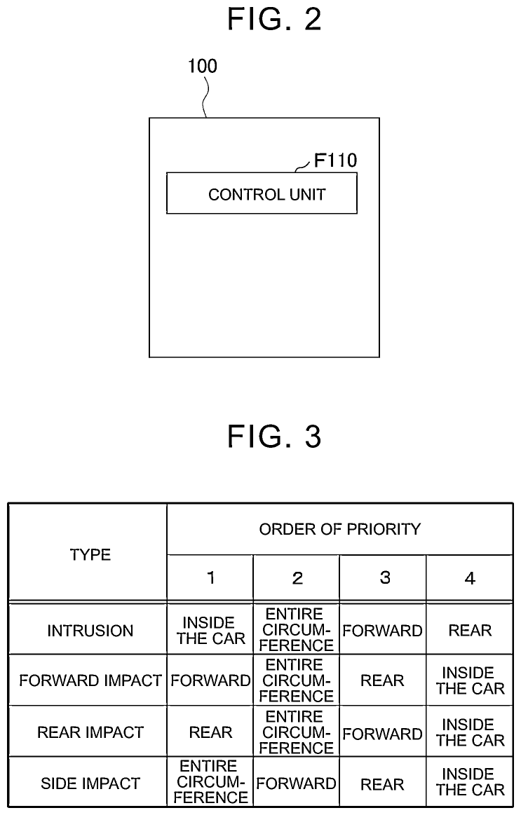

A software configuration of the in-vehicle device 100 according to the present embodiment will be described with reference to FIG. 2. As illustrated in FIG. 2, the in-vehicle device 100 includes a control unit F110 as the software module. Note that the software configuration of the in-vehicle device 100 is not limited to the example illustrated in FIG. 2, and the components may be added or replaced as appropriate.

The control unit F110 is realized by the processor 101 of the in-vehicle device 100 loading a dedicated program stored in the auxiliary storage device 103 into the main storage device 102 and executing the program. Note that the control unit F110 may be realized by hardware circuitry such as Application Specific Integrated Circuit (ASIC) or Field Programmable Gate Array (FPGA).

When the control unit F110 senses a predetermined event when the vehicle 10 is parked, it starts recording by the cameras 104 to 107. The parking state of the vehicle 10 is a state in which the drive system is stopped (the ignition switch or the power switch is turned off), the door is locked, and the occupant has got off. The determination as to whether the occupant has finished getting off may be performed according to the image-capturing data of the in-vehicle camera 107 or may be performed according to the detection signal of the seating sensor. Alternatively, the determination as to whether or not the occupant has got off may be performed in accordance with the determination as to whether or not a smart key does not exist in the vehicle of the vehicle 10.

The predetermined event in the present embodiment is an entry of a moving object (for example, a person or the like) into the interior of the vehicle 10 and an impact of the vehicle 10. The intrusion of the moving body into the interior of the vehicle 10 is sensed through the intrusion sensor 108. Incidentally, the intrusion of the moving body into the interior of the vehicle 10 may be determined according to whether or not an unlock of the door by an improper method is sensed. The impact of the vehicle 10 is sensed through the multi-axis acceleration sensor 109.

When a predetermined event occurs while the vehicle 10 is parked, the control unit F110 starts recording by the cameras 104 to 107. In this case, the recording time by the cameras 104 to 107 may be a predetermined time length (for example, several minutes to several tens of minutes) set in advance in one example. In another example, the recording time by the cameras 104-107 may be changed depending on the type of predetermined event. That is, when the predetermined event is an impact of the vehicle 10, recording is performed for a predetermined period of time that is set in advance. In a case where the predetermined event is an intrusion of a moving body into the interior of the vehicle 10, the recording may be performed until the moving body leaves the interior of the room.

Further, the control unit F110 determines the type of the predetermined event. As used herein, the “type of a predetermined event” includes an intrusion of a moving body into the room of the vehicle 10, an impact from the front of the vehicle 10, an impact from the back of the vehicle 10, and an impact from the side of the vehicle 10. When a predetermined event is sensed by the intrusion sensor 108, the control unit F110 determines that the type of the predetermined event is “intrusion of a moving object into the interior of the vehicle 10”. When a predetermined event is sensed by the multi-axis acceleration sensor 109, the control unit F110 analyzes the detected signal of the multi-axis acceleration sensor 109 to determine the direction of the impact received by the vehicle 10. That is, the control unit F110 determines whether it is an impact from the front of the vehicle 10, an impact from the rear of the vehicle 10, or an impact from the side of the vehicle 10.

When the type of the predetermined event is determined, the control unit F110 decides the order of priority of the four pieces of recorded data recorded by the four cameras 104 to 107 according to the determined type of the predetermined event. At this time, the control unit F110 decides the highest order of priority of precedence of the recording data having the highest relevance to the predetermined event. Here, an example of the order of priority of the recording data is shown in FIG. 3.

In the example illustrated in FIG. 3, the order of priority in the case where the type of the predetermined event is the intrusion of the moving body into the interior of the vehicle 10 (“intrusion” in FIG. 3) is set in the order of “recording data of the in-vehicle camera 107”, “recording data of all surrounding cameras 106”, “recording data of the front camera 104”, and “recording data of the rear camera 105” from the upper level.

The order of priority in the case where the type of the predetermined event is an impact from the front of the vehicle 10 (“forward impact” in FIG. 3) is set in the order of “recording data of the front camera 104”, “recording data of all surrounding cameras 106”, “recording data of the rear camera 105”, and “recording data of the in-vehicle camera 107” from the upper level.

The order of priority in the case where the type of the predetermined event is an impact from the rear side of the vehicle 10 (“rear impact” in FIG. 3) is set in the order of “recording data of the rear camera 105”, “recording data of all surrounding cameras 106”, “recording data of the front camera 104”, and “recording data of the in-vehicle camera 107” from the upper level.

The order of priority in the case where the type of the predetermined event is an impact from the side of the vehicle 10 (“lateral impact” in FIG. 3) is set in the order of “recording data of all surrounding cameras 106”, “recording data of front cameras 104”, “recording data of rear cameras 105”, and “recording data of in-vehicle cameras 107” from the top.

Note that the order of priority shown in FIG. 3 is merely an example, and the recording data other than the highest-order recording data (first-order recording data) may be appropriately changed according to the embodiment.

When the order of priority of the four pieces of recorded data recorded by the four cameras 104 to 107 is decided, the control unit F110 uploads the four pieces of recorded data to the servers 200 in accordance with the determined order of priority. In an example, when the type of the predetermined event is the intrusion of the moving body into the interior of the vehicle 10, the recording data is uploaded to the server 200 in the order of “recording data of the in-vehicle camera 107”, “recording data of the all surrounding cameras 106”, “recording data of the front camera 104”, and “recording data of the rear camera 105”. When the type of the predetermined event is an impact from the front of the vehicle 10, the recording data is uploaded to the server 200 in the order of “recording data of the front camera 104”, “recording data of the entire surrounding camera 106”, “recording data of the rear camera 105”, and “recording data of the in-vehicle camera 107”. When the type of the predetermined event is an impact from the rear of the vehicle 10, the recording data is uploaded to the server 200 in the order of “recording data of the rear camera 105”, “recording data of the entire surrounding camera 106”, “recording data of the front camera 104”, and “recording data of the in-vehicle camera 107”. When the type of the predetermined event is an impact from the side of the vehicle 10, the recording data is uploaded to the server 200 in the order of “recording data of the all-around camera 106”, “recording data of the front camera 104”, “recording data of the rear camera 105”, and “recording data of the in-vehicle camera 107”.

Note that the upload of the recording data may be performed after the recording by the cameras 104 to 107 is completed, or may be performed concurrently with the recording by the cameras 104 to 107.

In addition, recording by the cameras 104 to 107 may be performed at all times while the vehicle 10 is parked. In this case, the control unit F110 may upload, to the servers 200, recording data of a predetermined time length including the time when and before and after a predetermined event among the recording data of each of the cameras 104 to 107.

### Processing Flow

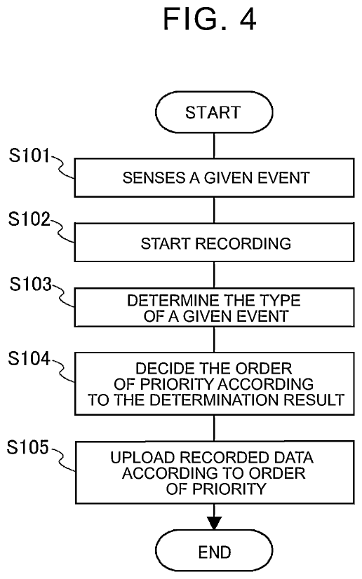

Next, a flow of processing executed by the in-vehicle device 100 according to the present embodiment will be described with reference to FIG. 4. FIG. 4 is a flowchart illustrating a processing routine executed by the in-vehicle device 100 when a predetermined event occurs while the vehicle 10 is parked (when an ignition switch, a power switch, or the like is in an off state). The processor 101 of the in-vehicle device 100 is the execution subject of the process routine of FIG. 4, and the software module (control unit F110) of the in-vehicle device 100 is used as the execution subject.

In the process of FIG. 4, the control unit F110 senses the occurrence of a predetermined event through the intrusion sensor 108 or the multi-axis acceleration sensor 109 (S101). When the control unit F110 finishes executing S101 process, it executes S102 process.

In S102, the control unit F110 transmits a recording start command to each of the cameras 104 to 107 to start recording by the cameras 104 to 107. When the control unit F110 finishes executing S102 process, it executes S103 process.

In S103, the control unit F110 determines the type of the predetermined event. At this time, if the predetermined event is sensed by the intrusion sensor 108, the control unit F110 determines that the type of the predetermined event is “intrusion of a moving object into the interior of the vehicle 10”. If a predetermined event is sensed by the multi-axis acceleration sensor 109, the control unit F110 analyzes the detected signal of the multi-axis acceleration sensor 109 to determine the direction of the impact received by the vehicle 10. That is, the control unit F110 determines whether the type of the predetermined event is “impact from the front of the vehicle 10”, “impact from the rear of the vehicle 10”, or “impact from the side of the vehicle 10”. When the control unit F110 finishes executing S103 process, it executes S104 process.

In S104, the control unit F110 decides the order of priority of the four pieces of recorded data by the four cameras 104 to 107 according to the type of the predetermined event determined by S103. In an exemplary embodiment, the control unit F110 may decide the order of priority of the four pieces of recorded data in accordance with the order illustrated in FIG. 3. When the control unit F110 finishes executing S104 process, it executes S105 process.

In S105, the control unit F110 uploads four pieces of recording data by the four cameras 104 to 107 to the servers 200 in accordance with the order of priority decided by S104. When the control unit F110 finishes executing S105 processing, it finishes executing this processing routine.

### Operation and Effect of Embodiments

In the in-vehicle device 100 of the above-described embodiment, when a predetermined event is sensed during parking of the vehicle 10, the type of the predetermined event is determined. Then, the order of priority of the four pieces of recorded data by the four cameras 104 to 107 is decided according to the determination result. In the in-vehicle device 100 according to the present embodiment, four pieces of recorded data are uploaded to the server 200 in accordance with the decided order of priority.

Therefore, according to the in-vehicle device 100 of the present embodiment, among the four pieces of recording data recorded by the four cameras 104 to 107, it is possible to preferentially upload the recording data having the highest relevance to the predetermined event to the server 200. As a result, even when the capacity of recorded data that can be uploaded from the in-vehicle device 100 to the server 200 at the time of occurrence of a predetermined event per time or the communication time length that can be spent for uploading is limited, it is possible to more reliably upload recorded data having the highest relevance to a predetermined event to the server 200. As a result, the security of the parked vehicle 10 can be ensured more reliably.

### Other

The above-described embodiment is merely an example, and the present disclosure can be appropriately modified and implemented without departing from the gist thereof. For example, the number of cameras mounted on the vehicle 10 is not limited to four, and may be three or less, or may be five or more. Here, in a case where an impact is sensed in a vehicle equipped with only an all-around camera and an in-vehicle camera, the order of priority of the recorded data of all-around cameras may be decided to be the highest.

In addition, in a case where an impact is sensed in a vehicle not equipped with the multi-axis acceleration sensor, the order of priority of the recorded data of the all-around cameras may be decided to be the highest. Alternatively, it may be determined whether the vehicle is forward-facing parking or backward-facing parking, and whether the vehicle is forward-facing impact or backward-facing impact, and the order of priority may be decided according to the determination result.

Further, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device installed in a vehicle that is equipped with a plurality of cameras, the information processing device comprising: a control unit configured to execute
deciding, in accordance with a predetermined event occurring while the vehicle is parked, an order of priority of a plurality of pieces of recorded data recorded by the cameras, and
uploading the recorded data to a predetermined server in an order in accordance with the order of priority.

2. The information processing device according to claim 1, wherein
the cameras include a first camera for shooting forward of the vehicle, a second camera for shooting rearward of the vehicle, a third camera for shooting a vicinity of the vehicle, and a fourth camera for shooting inside a cabin of the vehicle, and
when the predetermined event is sensing of intrusion into the cabin of the vehicle, the control unit decides the order of priority of the recorded data of the fourth camera to be the highest priority.

3. The information processing device according to claim 2, wherein, when the predetermined event is sensing of impact, the control unit decides the order of priority of the recorded data of the third camera to be the highest priority.

4. The information processing device according to claim 2, wherein
the vehicle includes a multi-axis acceleration sensor, and
when the predetermined event is sensing of impact, the control unit executes
determining a direction from which the vehicle was subjected to an impact based on a detection signal of the multi-axis acceleration sensor,
deciding the order of priority of the recording data of the first camera to be the highest priority when determination is made that the vehicle was subjected to an impact from a front,
deciding the order of priority of the recording data of the second camera to be the highest priority when determination is made that the vehicle was subjected to an impact from a rear, and
deciding the order of priority of the recording data of the third camera to be the highest priority when determination is made that the vehicle was subjected to an impact from a side.
